(19) United States
(12) Patent Application Publication
(10) Pub. No.: US 2004/0019634 A1
(43) Pub. Date: Jan. 29, 2004

(54) Methods and apparatus for facilitating revisions to content

(76) Inventors: Anne Van Geldern, Rowayton, CT (US); Thuan Truong, Johnson City, NY (US); Leonard S. Kim, Cos Cob, CT (US)

Correspondence Address: BUCKLEY, MASCHOFF, TALWALKAR LLC, 5 ELM STREET, NEW CANAAN, CT, 06840, US

(21) Appl. No.: 10/205,931

(22) Filed: Jul. 26, 2002

(51) Int. Cl. G06F 15/16

(52) U.S. Cl. 709/203

(57) ABSTRACT

A system, method, apparatus, means, and computer program code for allowing or facilitating the updating of a database, Web site or other electronic resource. In some embodiments, an entity or a device (hereinafter referred to as the “coordinator”) may maintain, facilitate or provide an electronic resource that uses content provided, managed or controlled by one or more other parties (hereinafter referred to as “content contacts” or “content managers”). The coordinator may send periodic recency notifications to the content contacts requesting that they review their associated content and provide updates or revisions to the content if necessary.

### FIELD OF THE INVENTION

The present invention relates to a method and apparatus for managing or coordinating updates to content provided via an electronic resource and, more particularly, embodiments of the present invention relate to methods, means, apparatus, and computer program code for facilitating communication between parties having abilities to change the content and/or approve changes to the content.

### BACKGROUND OF THE INVENTION

Many companies, organizations, etc. maintain or use electronic resources (e.g., World Wide Web sites, databases, logs) to provide or facilitate information. For example, a company may provide a Web site at which product and location information regarding the company can be found. The Web site may include many Web pages devoted to different products, different company offices, etc. Thus, the Web site may include many portions of content that periodically need to be reviewed for currency (i.e., accuracy), updated, deleted, or revised when possible or when necessary, etc.

Unfortunately, the bigger, layered or more complex an electronic resource, the more complex management and coordination of the electronic resource may be and the more people, devices and systems needed to manage it. This problem may be further complicated by an electronic resource that facilitates information and other content from a variety of sources, countries, different business units, etc. that may be based on or written in different languages, cultures, business practices, traditions, etc.

It would be advantageous to provide a method and apparatus that overcame the drawbacks of the prior art. In particular, it would be desirable to provide a method and apparatus that facilitated the review and/or revising of content for an electronic resource.

### SUMMARY OF THE INVENTION

Embodiments of the present invention provide a system, method, apparatus, means, and computer program code for allowing or facilitating the reviewing and/or updating of a database, Web site or other electronic resource. In some embodiments, the present invention is directed to helping an entity or device (hereinafter referred to as the “coordinator”) maintain, facilitate or provide an electronic resource that may use content provided or controlled by one or more other parties or devices (hereinafter referred to as “content contacts” or “content managers”). In some embodiments, the present invention also may facilitate communication between different parties regarding the content use on or provided in an electronic resource. In some embodiments, an electronic resource may be or include a document, file, World Wide Web (“Web”) page or site, database, log, etc.

Additional advantages and novel features of the invention shall be set forth in part in the description that follows, and in part will become apparent to those skilled in the art upon examination of the following or may be learned by the practice of the invention.

According to some embodiments of the present invention, a method for facilitating updates to content for an electronic resource may include providing a plurality of recency notifications to a respective plurality of content contacts regarding a plurality of portions of content for an electronic resource, wherein each of the plurality of content contacts is associated with a respective one of the plurality of portions of content and wherein a recency notification sent to one of the plurality of content contacts includes data indicative of a location of one of the plurality of portions of content associated with the one of the plurality of content contacts; and receiving at least one communication from at least one of the plurality of content contacts regarding one of the plurality of portions of content associated with the at least one of the plurality of content contacts. In another embodiment, a method for facilitating updates to content for an electronic resource may include providing a plurality of recency notifications to a respective plurality of content contacts, wherein each of the plurality of content contacts is associated with a respective portion of content for an electronic resource and wherein a recency notification sent to one of the plurality of content contacts includes data indicative of a location of one of the plurality of portions of content associated with the one of the plurality of content contacts; receiving a request to change at least one portion of content; making a determination regarding approval or rejection of the request; and providing a notification indicative of the determination. In a further embodiment, a method for facilitating updates to content for an electronic resource may include receiving a recency notification regarding content associated with an electronic resource, wherein the recency notification includes data indicative of a location of the content; determining if the content needs to be changed; and providing a response to the recency notification, wherein the response includes a change request if a change to the content is needed or the response includes a notification that no change to the content is needed. In yet another embodiment, a method for facilitating review of content for an electronic resource may include determining a plurality of portions of content for an electronic resource needing a review for currency; determining a plurality of content contacts associated with the plurality of portions of content; providing recency notifications to the plurality of the content contacts, wherein each of the plurality of recency notifications includes data indicative of a location of at least one of the portions of content; receiving either a request to change one of the plurality of portions of content or an indication that no change to the one of the plurality of portions of content is needed; and if the request is received, making a determination regarding approval or rejection of the request and providing a notification indicative of the determination.

According to some embodiments of the present invention, a system for facilitating review of content for an electronic resource may include a memory; a communication port; and a processor connected to the memory and the communication port, the processor being operative to provide a plurality of recency notifications to a respective plurality of content contacts regarding a plurality of portions of content for an electronic resource, wherein each of the plurality of content contacts is associated with a respective one of the plurality of portions of content and wherein a recency notification sent to one of the plurality of content contacts includes data indicative of a location of one of the plurality of portions of content associated with the one of the plurality of content contacts; and receive at least one communication from at least one of the plurality of content contacts regarding one of the plurality of portions of content associated with the at least one of the plurality of content contacts. In another embodiment, the processor may instead be operative to provide a plurality of recency notifications to a respective plurality of content contacts, wherein each of the plurality of content contacts is associated with a respective portion of content for an electronic resource and wherein a recency notification sent to one of the plurality of content contacts includes data indicative of a location of one of the plurality of portions of content associated with the one of the plurality of content contacts; receive a request to change at least one portion of content; make a determination regarding approval or rejection of the request; and provide a notification indicative of the determination. In a further embodiment, the processor may instead be operative to receive a recency notification regarding content associated with an electronic resource, wherein the recency notification includes data indicative of a location of the content; determine if the content needs to be changed; and provide a response to the recency notification, wherein the response includes a change request if a change to the content is needed or the response includes a notification that no change to the content is needed. In yet another embodiment, the processor may be operative to determine a plurality of portions of content for an electronic resource needing a review for currency; determine a plurality of content contacts associated with the plurality of portions of content; provide recency notifications to the plurality of the content contacts, wherein each of the plurality of recency notifications includes data indicative of a location of at least one of the portions of content; receive either a request to change one of the plurality of portions of content or an indication that no change to the one of the plurality of portions of content is needed; and if the request is received, make a determination regarding approval or rejection of the request and provide a notification indicative of the determination. In a still further embodiment, the processor may be operative to provide a plurality of notifications to a respective plurality of content contacts regarding a plurality of portions of content for an electronic resource, wherein each of the plurality of content contacts is associated with a respective one of the plurality of portions of content and wherein a notification sent to one of the plurality of content contacts includes data indicative of a location of one of the plurality of portions of content associated with the one of the plurality of content contacts; facilitate access to the plurality of portions of content for review by the plurality of content contacts; receive indications regarding need for changes to the portions of content; and provide indications regarding whether the plurality of portions of content have been reviewed by the plurality of content contacts.

According to some embodiments of the present invention, a computer program product in a computer readable medium for facilitating review of content for an electronic resource may include first instructions for sending a plurality of recency notifications to a respective plurality of content contacts regarding a plurality of portions of content for an electronic resource, wherein each of the plurality of content contacts is associated with a respective one of the plurality of portions of content and wherein a recency notification sent to one of the plurality of content contacts includes data indicative of a location of one of the plurality of portions of content associated with the one of the plurality of content contacts; and second instructions for obtaining at least one communication from at least one of the plurality of content contacts regarding one of the plurality of portions of content associated with the at least one of the plurality of content contacts. In another embodiment, a computer program product in a computer readable medium for facilitating review of content for an electronic resource may include first instructions for sending a plurality of recency notifications to a respective plurality of content contacts, wherein each of the plurality of content contacts is associated with a respective portion of content for an electronic resource and wherein a recency notification sent to one of the plurality of content contacts includes data indicative of a location of one of the plurality of portions of content associated with the one of the plurality of content contacts; second instructions for obtaining a request to change at least one portion of content; third instructions for establishing or making a determination regarding approval or rejection of the request; and fourth instructions for sending a notification indicative of the determination. In a further embodiment, a computer program product in a computer readable medium for facilitating updates to content for an electronic resource may include first instructions for obtaining a recency notification regarding content associated with an electronic resource, wherein the recency notification includes data indicative of a location of the content; second instructions for making a determination of whether the content needs to be changed; and third instructions for sending a response to the recency notification, wherein the response includes a change request if a change to the content is needed or the response includes a notification that no change to the content is needed. In yet another embodiment, a computer program product in a computer readable medium for facilitating review of content for an electronic resource may include first instructions for identifying a plurality of portions of content for an electronic resource needing a review for currency; second instructions for identifying a plurality of content contacts associated with the plurality of portions of content; third instructions for sending recency notifications to the plurality of the content contacts, wherein each of the plurality of recency notifications includes data indicative of a location of at least one of the portions of content; fourth instructions for obtaining either a request to change one of the plurality of portions of content or an indication that no change to the one of the plurality of portions of content is needed; and if the request is received, fifth instructions for establishing or making a determination regarding approval or rejection of the request and sending a notification indicative of the determination.

According to some embodiments of the present invention, an apparatus for facilitating review of content for an electronic resource may include means for sending a plurality of recency notifications to a respective plurality of content contacts regarding a plurality of portions of content for an electronic resource, wherein each of the plurality of content contacts is associated with a respective one of the plurality of portions of content and wherein a recency notification sent to one of the plurality of content contacts includes data indicative of a location of one of the plurality of portions of content associated with the one of the plurality of content contacts; and means for obtaining at least one communication from at least one of the plurality of content contacts regarding one of the plurality of portions of content associated with the at least one of the plurality of content contacts. In another embodiment, an apparatus for facilitating review of content for an electronic resource may include means for sending a plurality of recency notifications to a respective plurality of content contacts, wherein each of the plurality of content contacts is associated with a respective portion of content for an electronic resource and wherein a recency notification sent to one of the plurality of content contacts includes data indicative of a location of one of the plurality of portions of content associated with the one of the plurality of content contacts; means for obtaining a request to change at least one portion of content; means for establishing or making a determination regarding approval or rejection of the request; and means for sending a notification indicative of the determination. In a further embodiment, an apparatus for facilitating updates to content for an electronic resource may include means for obtaining a recency notification regarding content associated with an electronic resource, wherein the recency notification includes data indicative of a location of the content; means for making a determination of whether the content needs to be changed; and means for sending a response to the recency notification, wherein the response includes a change request if a change to the content is needed or the response includes a notification that no change to the content is needed. In yet another embodiment, an apparatus in a computer readable medium for facilitating review of content for an electronic resource may include means for identifying a plurality of portions of content for an electronic resource needing a review for currency; means for identifying a plurality of content contacts associated with the plurality of portions of content; means for sending recency notifications to the plurality of the content contacts, wherein each of the plurality of recency notifications includes data indicative of a location of at least one of the portions of content; means instructions for obtaining either a request to change one of the plurality of portions of content or an indication that no change to the one of the plurality of portions of content is needed; and if the request is received, means for establishing or making a determination regarding approval or rejection and sending a notification indicative of the determination.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is an illustration of an example Web page for a Web site modified via the methods of the present invention;

FIG. 2 is an illustration of another example Web page for the Web site of FIG. 1;

FIG. 3 is a block diagram of entities involved with the methods of the present invention;

FIG. 4 is an alternative block diagram of the entities of FIG. 3;

FIG. 5 is a flowchart of a first embodiment of a method in accordance with the present invention that is implementable by the coordinator of FIGS. 3 and 4;

FIG. 6 is a flowchart of a second embodiment of a method in accordance with the present invention that is implementable by the coordinator of FIGS. 3 and 4;

FIG. 7 is a flowchart of a third embodiment of a method in accordance with the present invention that is implementable by a content contact of FIGS. 3 and 4;

FIG. 8 is a flowchart of a fourth embodiment of a method in accordance with the present invention that is implementable by the coordinator of FIGS. 3 and 4;

FIG. 9 is a flowchart of a fifth embodiment of a method in accordance with the present invention that is implementable by a content contact of FIGS. 3 and 4;

FIG. 10 is a block diagram of components for an embodiment of a coordinator device that may be used by or with the coordinator of FIGS. 3 and 4;

FIG. 11 is an illustration of a representative content contact information database of FIG. 10;

FIG. 12 is an illustration of an interface that may be used to indicate whether changes to content are needed;

FIG. 13 is an illustration of an interface that may be used to enter a proposed change to a portion of content;

FIG. 14 is an illustration of an interface that may be used to review a proposed change to a portion of content;

FIG. 15 is an illustration of an interface that may be used to review status of recency notifications; and

FIG. 16 is and illustration of an interface that may be used to review status of change requests.

### DETAILED DESCRIPTION

Applicants have recognized that there is a need for systems, computer code. means and methods that allow or facilitate the updating or revising of a database, Web site or other electronic resource. In some embodiments, the present invention is directed to helping an entity or device (hereinafter referred to as the “coordinator”) maintain, facilitate or provide an electronic resource that may use content provided or controlled by one or more other parties or devices (hereinafter referred interchangeably to as “content contacts” or “content managers”). In some embodiments, the present invention also may facilitate communication between different parties regarding content used on or provided in an electronic resource. In some embodiments, an electronic resource may be or include a document, file, World Wide Web (“Web”) page or site, database, log, etc. For example, in some embodiments, content may be or include one or more of the following: text; an image; a description of a product or service; an advertisement; a banner; contact information for a corporate entity or individual; etc. The terms “coordinator”, “content contact”, “contact manager” and “local business unit” are used herein for purposes of convenience of explanation and reference and are not used to imply or require, and do not imply or require, any specific limitation(s) regarding their structure, operation, identification, implementation, configuration, etc.

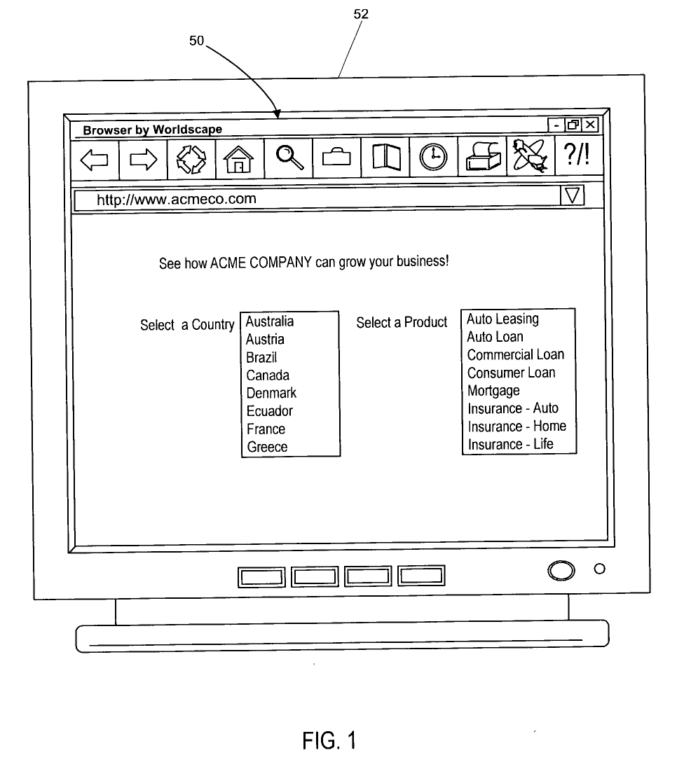

As one illustration of how the methods and systems of the present invention may be used, a coordinator may implement, manage, coordinate or host a Web site (e.g., the electronic resource) on behalf of an entity (e.g., company, organization) wherein portions of the content on the Web site are provided by a respective plurality of distinct content contacts. For example, the Web site may be used to provide general information regarding the ACME Company and the different products and services the ACME Company offers, the different company offices, etc., as illustrated by Web page 50 displayed on computer 52 in FIG. 1. The ACME Company may offer different selections of products and services in different cities, states, countries, or other geographic regions.

The Web site may include one or more pages directed to each of the different geographic regions, the content of which is provided by content contacts associated with the different geographic regions. The coordinator may provide, use or enforce use of a template and/or guidelines for the content contacts to use when creating or updating content. For example, the template may provide an initial or home page to the Web site that includes general content related to the ACME Company provided or controlled by the coordinator. The Web site may then include a list or menu of different countries where products and services offered by the ACME Company are offered or are available, as illustrated in the representative Web page 50.

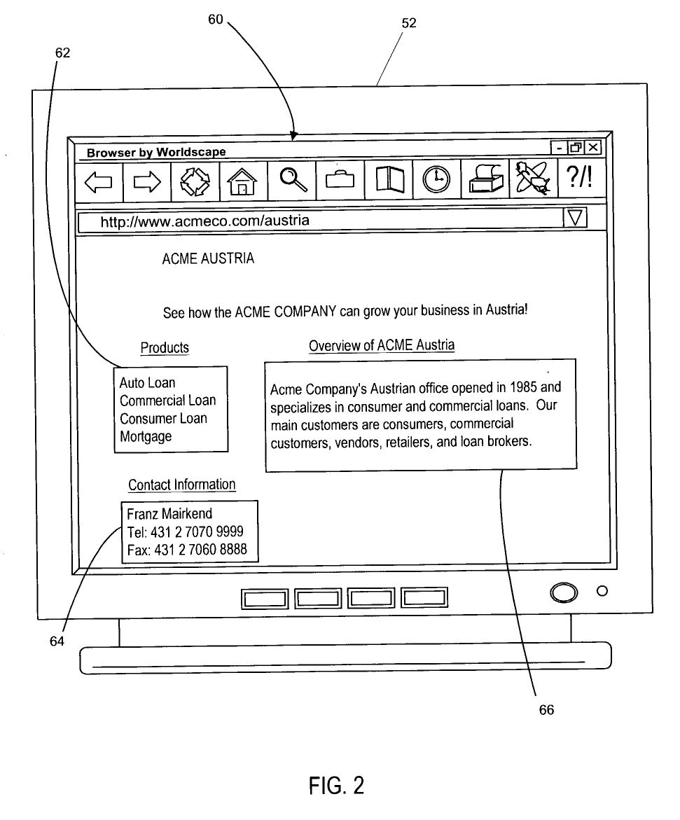

Clicking on or otherwise selecting one the countries on the Web page 50 may take a user to another Web page 60 illustrated in FIG. 2 that is specific to the country that may list or provide information for, among other things: (1) contact information (e.g., address, telephone number, email address, facsimile number, name) for a subsidiary, affiliate, office, partner, etc. (hereinafter referred to as “affiliate”) of the ACME Company available in the country; (2) information regarding the products or services available in the country from the ACME Company or its affiliate, etc.; (3) general information about the company's affiliate in the country; etc. Different products and services may be available in different countries.

As the ACME Company or the coordinator may want to have a consistent or similar look and feel, organization, corporate branding, etc. for each of the Web pages devoted to different countries, the template provided or used for the Web pages may limit the type, length, font, colors, language, and organization of information that can be provided on or used with a Web page devoted to a particular country, the layout of the information on the Web page, etc. However, some or all the actual content on the Web page for a specific country may be provided by a content contact assigned to such specific country's Web page. For example, the location, color, font, and maximum size of content blocks 62, 64 and 66 may be dictated by the template while the text or other content used for or within the content blocks 62, 64, 66 may vary within the prescribed limits of the template and may be provided or approved by the designated content contact. Different Web pages, or different content blocks on a Web page, may have different content contacts responsible for different portions of content.

Different countries may have different content contacts that provide information, update such information, etc. In this manner, the coordinator may retain overall control or management of the Web site while content contacts are responsible for specific portions or pages of the content for the Web site and may tailor their content within the guidelines of the template to meet local customs and business practices, provide tailored information, etc.

As a more specific example, the Web site may be directed to financial services provided by the ACME Company. The ACME Company may have, own, have relationships with, or use affiliates in different countries, each of which may provide some or all of a group of financial services approved by the ACME Company for their respective countries. Each of the affiliates may have an associated content contact responsible for providing, updating and/or approving the content associated with the country on the Web site. The services may be or include consumer and/or commercial oriented services such as automobile loans, automobile leasing, commercial loans, consumer loans, insurance, mortgages, private label credit cards, etc. The ACME Company's affiliate in Brazil may offer all of these products/services while the ACME Company's affiliate in Spain may offer only the automobile leasing and loan services. For example, the Austrian affiliate of the ACME Company offers loans but does not provide insurance, as indicated in the content block 62 of FIG. 2. A similar Web page devoted to the Brazilian affiliate of the ACME Company may list all of the products/services indicated on the Web page 50 while a Web page devoted to the Spanish affiliate of the ACME Company may list only the automobile leasing and loan products/services in a content block similar to the content block 62.

In order to maintain currency of the Web site, the coordinator may send one or more recency notifications to one or more content contacts requesting that the content contacts review their respective associated content and then provide a notification back to the coordinator that either (1) their respective associated content does not need to be changed or updated; or (2) their respective associated content does need to be changed or updated. For example, the ACME Company operating a central Web site may have affiliates in Austria, Japan and Peru, each of which has a designated content contact for content relating to the affiliates'content on the Web site. Once a quarter, a coordinator associated with the Web site may send an email message to the three content contacts requesting that they review their respective associated content on the Web site. The content contact for the Austrian affiliate may then review the content on the Web site associated with the Austrian affiliate and report via an email message to the coordinator that no changes to such content on the Web site are currently needed. Alternatively, the content contact for the Austrian affiliate may then review the content on the Web site associated with the Austrian affiliate and report via an email message to the coordinator that one or more changes to such content on the Web site are currently needed. The coordinator may be an employer, agent, contractor, etc. of the ACME Company or have some other relationship with the ACME Company that allows the coordinator to act on its behalf. In some embodiments, the coordinator may have final review and/or approval rights for all proposed changes to content, even if the changes already have been approved by one or more other parties. In some embodiments, one a change to a portion of content has been approved by the coordinator and/or another party, the coordinator or the other party may provide a notification to a Web site hoster or Web site coder to implement the change to the content.

A technical effect provided by the methods and systems of the present invention is that the methods and systems of the present invention provide an efficient and effective manner for the coordinator to facilitate communications to and from multiple content contacts and other related parties and to facilitate timely updates to an electronic resource, as will be discussed in more detail below.

System

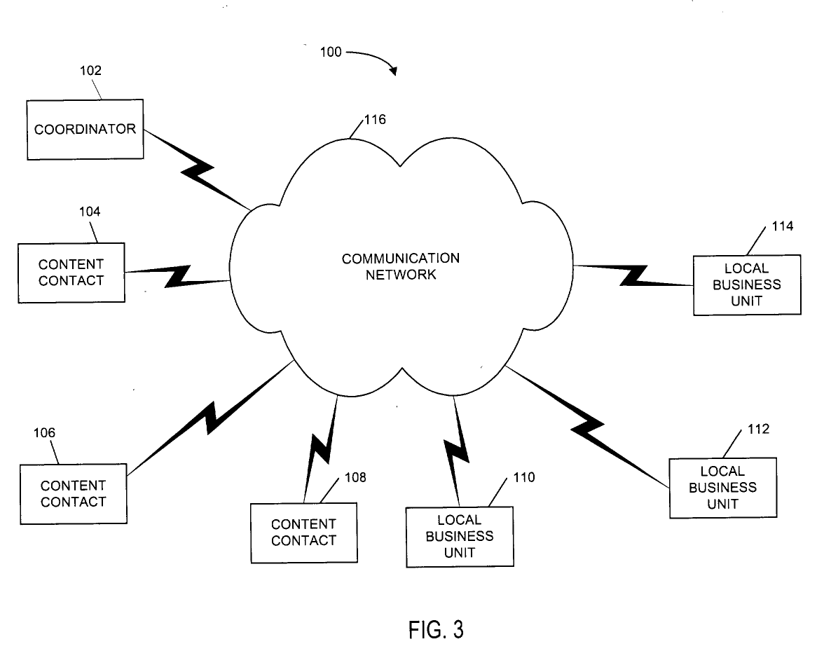

Now referring to FIG. 3, an apparatus or system 100 usable with the methods disclosed herein is illustrated. The system 100 also includes at least one coordinator 102, one or more content contacts 104, 106, 108, as previously described above. In addition, the system 100 may include one or more local business units 110, 112, 114, as previously described above. The terms “coordinator”, “content contact” and “local business unit” are used for explanatory purposes and no specific limitation or definition is meant or implied by their use. The coordinator 102 may be or include an individual, business entity, Web site, software program, device, or collection or group of one or more of these.

In some embodiments, the coordinator 102 may be, include, or be part of a system for facilitating review of content for an electronic resource. For example, the system may keep track of, archive, monitor, etc. content used on or with an electronic resource (e.g., a company's Web site). The system may identify or determine when a portion of content associated with the electronic resource needs to be reviewed. At appropriate or designated times, the system may provide a one or more notifications to a respective one or more content contacts regarding one or more portions of content for an electronic resource in need of review. Different content contacts may be associated with different portions of content. The system may determine which content contacts are associated with which portions of content. For example, the system may have, maintain or have access to a database that relates specific portions of content to specific content contacts.

A notification sent by the system to a content contact may include data indicative of a location of one of the plurality of portions of content associated with content contact. The location may be or include a Web site, database or other electronic resource that the content contact may have to access to review the content, provide or indicate changes to the content, etc. Once the content contact has accessed the Web site, database or other electronic resource, the content contact may then be allowed to view and access, retrieve, view, etc. the content that needs to be reviewed (which may be stored on a different Web site, database or other electronic resource). In some embodiments, data indicative of a location of content may include data indicative of an intermediary location that must be accessed prior to accessing the content, but not data indicative of the final location of the content. The system may allow other people to view proposed changes to content, approve or deny proposed changes to content, provide messages to people that must approve changes to content that they need to review the proposed changes, etc.

The coordinator 102, client contacts 104, 106, 108 and/or the local business units 110, 112, 114 may communicate via a computer, date, telephone or other communication network 116. The communications network 116 might be or include the Internet, the World Wide Web, or some other public or private computer, cable, telephone, client/server, peer-to-peer, or communications network or intranet. The communications network 116 illustrated in FIG. 1 is meant only to be generally representative of cable, computer, telephone, peer-to-peer or other communication networks for purposes of elaboration and explanation of the present invention and other devices, networks, etc. may be connected to the communications network 116 without departing from the scope of the present invention. The communications network 116 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, content contact may be in direct communication with the coordinator 102 and/or a local business unit without departing from the scope of the present invention. Moreover, as used herein, communications include those enabled by wired or wireless technology.

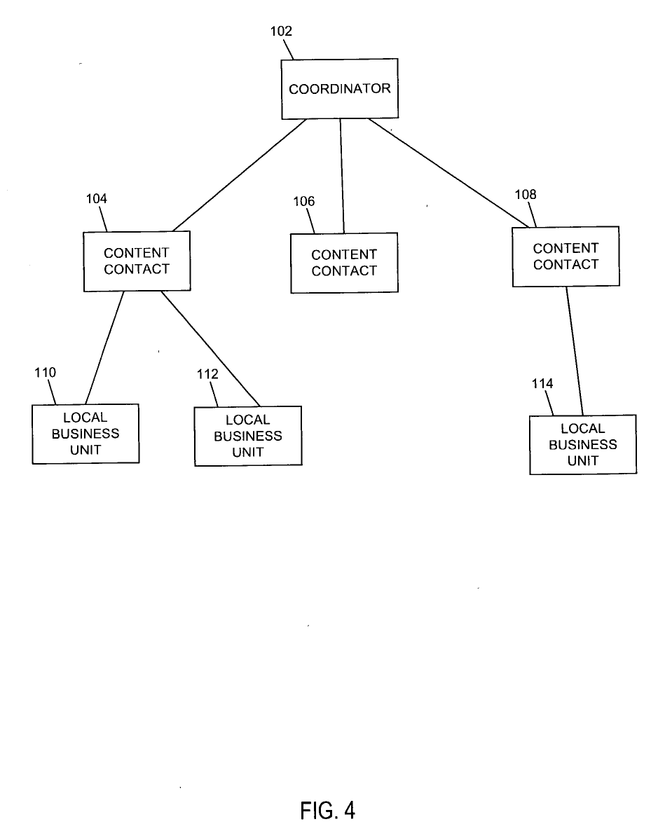

As previously discussed above, for purposes of monitoring and approving content, making updates to content, etc., the coordinator 102, content contacts 104, 106, 108, and local business units 110, 112, 114 may be arranged in a hierarchal manner as illustrated in FIG. 4. That is, the content contacts 104, 106, 108 have some reporting or communications duties to the coordinator 102 and may receive recency notifications from the coordinator 102 regarding portions of content for an electronic resource that the content contacts 104, 106, 108 are responsible for managing or updating. The client contacts 104, 106, 108 may be located in different countries, different geographic regions, etc. and may interact with local business units in their respective countries, geographic regions, etc. For example, the content contact 104 may interact primarily or exclusively with the local business units 110, 112 but not with the local business unit 114. The local business unit 114 may interact primarily or exclusively with the content contact 114 but not directly with the content contacts 104, 106.

While not illustrated in FIG. 3 or 4, in some embodiments the system 100 may include other entities, such as Web site hosters, software programmers, etc. that may be involved in the content updating process. For example, once a change to content to a Web site is approved, the change may be sent to a software programmer or coder that codes the content change. The changed content for the Web site can then be sent to the Web site hoster for implementation and hosting.

Many different types of implementations, network designs or hardware and software configurations can be used in the system 100 and with the methods disclosed herein and the methods disclosed herein are not limited to any specific hardware configuration for the system 100 or any of its components. In addition, although three content contacts 104, 106, 108 and three local business units 108, 110, 112 are shown in FIGS. 3 and 4, any number of such entities or their devices may be included in the system 100. The entities shown in FIG. 3 and 4 need not be in constant communication. For example, a content contact may communicate with the coordinator only when such communication is appropriate or necessary.

Process Description

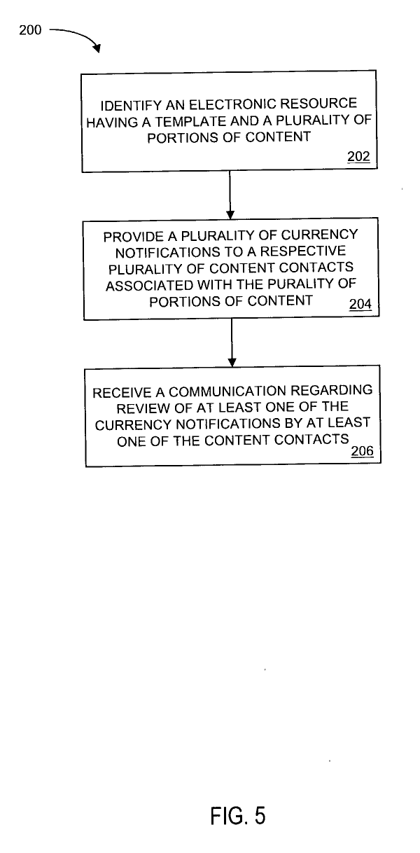

Reference is now made to FIG. 5, where a flow chart 200 is shown which represents the operation of a first embodiment of the present invention. The particular arrangement of elements in the flow chart 200 is not meant to imply a fixed order to the steps; embodiments of the present invention can be practiced in any order that is practicable. In some embodiments, some or all of the steps of the method 200 may be performed or completed by a server, user device and/or another device, as will be discussed in more detail below. The method 200 is particularly well suited for implementation by the coordinator 102. For purposes of explanation, but not limitation, the method 200 will be assumed to be implemented by or on behalf of the coordinator 102.

Processing begins at a step 202 during which the coordinator 102 establishes or otherwise identifies an online or other electronic resource having a template and a plurality of portions of content. The coordinator 102 may develop a template, receive a template from another entity or developer, be instructed or informed as to which template is associated with the electronic resource, or otherwise obtain a template from another source. In some embodiments, the step 202 may not be needed or may be considered optional.

The template may loosely or stringently dictate or control the placement, organization, format, location, look and feel, branding, style, color, animation, length, topic, language, etc. of one or more portions of content placed on or otherwise used with the online resource. For example, the template may include HTML coding for a Web site that provides placement for specific portions of content on and with different pages or other specific locations within the Web site. In some embodiments, information regarding one or more templates may be stored in a template information database.

Different portions of content may vary in length, style, color, topic, font, etc. within the confines of what is permissible under the template. The coordinator 102 may develop some or all of the portions of content itself, receive some or all of the portions of content from one or more content contacts, another entity or developer, etc., or otherwise obtain the some or all of the portions of content from another source. In some embodiments, information regarding one or more portions of content may be stored in a content information database.

As one possible implementation of the step 202, the coordinator 102 may design, develop or approve a template for an electronic resource, while some of all of the different portions of content used to populate the electronic template within the guidelines of the template are received by the coordinator 102 from one or more content contacts.

In some embodiments, an online or other electronic resource may be established or used directly or indirectly by, for or on behalf of the coordinator 102. For example, the coordinator 102 may host, implement and/or manage a Web site, database, document management system, etc. on behalf of itself or another party (e.g., the coordinator's employer, client, customer, associated organization, etc.).

During a step 204, the coordinator 102 may send a recency notification regarding portions of the content for the online resource to one or more client contacts associated with the content. For example, if the content contact 104 is associated with the Austrian affiliate of the ACME Company discussed above, the coordinator 102 may send a recency notification to the content contact 104 requesting that the content contact 104 review the content on the Web page associated with the Austrian affiliate. As another example, different portions of the content on the same Web page may be reviewed by different contact contents at the same or at different times, be associated with different recency notifications, etc. In some embodiments, the coordinator 102 may receive a confirmation of receipt of the recency notification sent during the step 202.

In some embodiments, the method 200 may include identifying or otherwise determining one or more portions of content associated with an electronic resource; identifying or otherwise determining one or more contact contacts associated with one or more portions of content for an electronic resource; associating one or more content contacts with one or more portions of content; determining a content contact associated with a portion of content; etc. In some embodiments, some of all of the portions of content for an electronic resource may need to be reviewed periodically (e.g., once a quarter), only when a business or product associated with the electronic resource changes, etc. Portions of content may have associated dates that indicate the last time they were reviewed or changed.

In some embodiments, the same recency notification may be sent to more than one content contact. In other embodiments, each content contact will receive a different recency notification. In some embodiments, more than one content contact may be asked to review the same content while in other embodiments each content contact will be asked to review different portions of content. As not all of the content for the electronic resource may need to be reviewed at the same time, in some embodiments recency notifications regarding different portions of content for or associated with the electronic resource may be sent at different times. Different recency notifications may be sent at different times, in different formats, via different communication channels, to one or more content contacts, etc.

In some embodiments, a recency notification sent to a content contact may include one or more of the following: an indication of the time and date the notification is being sent, an indication of the content that the content contact needs to review, a copy of the actual content that needs to be reviewed, a requested or required date by which the content contact should or must review the content, data (e.g., link, URL, computer address) that indicates where the content to be reviewed is or might be located, information regarding changes to a template, an identifier of the content, an identifier of the coordinator 102, an identifier associated with the coordinator 102, one or more instructions regarding what a receiver of the recency notification is to do while or after reviewing the content, passwords or other security information needed to view the content, information regarding suggested, requested or required changes to the content, contact information (e.g., email address, telephone number) for the coordinator 102, an identifier of an electronic resource, an identifier of a party needed for approval of a change to the content, an indication of an approval process associated with any change to the content, etc. In some embodiments, information regarding one or more content contacts may be stored in, or accessed from, a content contact information database.

As an example of the above, a recency notification sent by the coordinator 102 to the content contact 104 during the step 202 might include the link or URL “http://www.acmeco.com/austria” so that the content contact 104 will know what content to review, where the content to review is located, etc. Such information may make it easier for the content contact 104 to complete the review of the content, find the content to be reviewed, etc. In some embodiments, data indicative of a location of content to be reviewed may be or include data indicative of a Web site, database, or other electronic resource that that the content contact may have to access in order to gain access to the content. Once the content contact accesses the Web site, database or other electronic resource (which may be password protected), the content contact may then be allowed to view and access the content that needs to be reviewed (which may be stored on a different Web site, database or other electronic resource).

As another example, the recency notification sent by the coordinator 102 to the content contact 104 during the step 202 might include a link or URL to a Web site or Web page that requires the content contact 104 to provide a password, login, etc. before accessing a Web site, Web page, database, archive, etc. where the content to be reviewed is stored or at least where a copy of the content to be reviewed is stored. Different portions of content may have different security precautions, be stored in different locations, require different passwords for access, etc. Such Web site, database, archive, etc. may include or have previous versions of the content that is to be reviewed by the content contact 104, suggested version(s) of content or suggested revisions to the current content, etc., and may be separate from a Web site that makes such content publicly accessible (e.g., a test version of the Web site for evaluation as opposed to a production version of the Web site that is made publicly available).

A recency notification sent during the step 204 may be sent in or via one or more of a variety of formats or delivery channels. For example, the notification may be or include an email message, facsimile transmission, beeper or pager signal, HTML request, XML or FTP transmission, instant message communication, telephone or radio signal, or other electronic transmission. In some embodiments, information regarding one or more recency notifications may be stored in, or accessed from, a recency notification information database.

Once a content contact has received a recency notification, the content contact may have several options for action. For example, the content contact may ignore the recency notification, review the content as requested in the recency notification, respond to the recency notification, etc. A response sent by a content contact to a recency notification may include an indication of the time and date the notification is being sent, an indication of the content that the content contact reviewed, a copy of suggested or required changes to the content reviewed by the content contact, a request for approval of one or more changes to the content requested by the content contact, data (e.g., link, URL, computer address) that indicates where the suggested or required to the content is or might be located, contact information (e.g., email address, telephone number) for the content contact, an indication that no change to the content is required, etc.

For example, a response to the recency notification may indicate that the content contact has reviewed the content, that the content contact recommends or has changes to the content, that the content contact has no changes to the content, etc. In some embodiments, recommended changes to the content made by the content contact may be sent to the coordinator as part of a response to the recency notification received from the coordinator 102.

A response to recency notification sent during the step 204 may be sent in or via one or more of a variety of formats or delivery channels. For example, the response may be or include an email message, facsimile transmission, beeper or pager signal, HTML request, XML or FTP transmission, instant message communication, telephone or radio signal, or other electronic transmission. In some embodiments, information regarding one or more responses may be stored in, or accessed from, a response information database.

In some embodiments, if a content contact wishes to make changes to a portion of content, the content contact may need to obtain approval for such changes prior to sending a response or communication containing or indicative of the changes to the coordinator 102. Alternatively, the coordinator 102 may suggest or request, but not require, that the content contact get approval for changes suggested by the content contact. For example, the content contact may need to get approval for the proposed changes from a local business unit, a customer, or some other party. In some embodiments, the recency notification sent to the content contact during the step 202 may include instructions, contact information, etc., or data indicative of where information regarding such instructions, contact information, etc. might be found, related to the content approval process for the content. Different portions of content and/or different content contacts may have different approval procedures or requirements. In some embodiments, a communication or response received during the step 206 may indicate that a change to a portion of content is needed or requested. The coordinator 102 may then determine an entity (if any) that must approve the change and provide a notification to the entity indicative of the requested change, indicative of where the entity can find information regarding the requested change, indicative of the content contact making the change, etc. In some embodiments, the coordinator 102 may have the right to make the final decision regarding approval or disapproval of a proposed change to content, even if another party already has approved the change or commented on the change.

During a step 206, the coordinator 102 may receive directly or indirectly from content contact(s) one or more responses to or other communications regarding the recency notification(s) sent or otherwise provided by the coordinator 102 during the step 204. If necessary, in some embodiments, the coordinator 102 may review any recommended changes to content, reject or accept changes one or more recommended content changes, forward one or more content changes to another party for review, approval, and/or implementation, confirm receipt of the response, provide a notice to a content contact regarding approvals and/or rejections to the content contact's proposed content changes, request additional changes to the content, request information regarding the cost, benefit, time involved, labor involved, etc for or to implement one or more of the requested changes, forward the response to another party, etc.

In some embodiments, if a content contact does not review a portion of content as requested in a recency notification sent during the step 204, a system or entity implementing the method 200 or helping to implement one or more of the steps of the method 200 may send the coordinator 102 an email message, facsimile transmission, or other notification that the content associated with the recency notification has not been reviewed, approved, and/or updated. The coordinator 102 may then send a reminder or follow-up or reminder recency notification to the content contact, locate a new content contact to whom to send the recency notification, etc.

In some embodiments, a response to a recency notification may be or include one or more of the following: an identifier (e.g., name, code, email address) of a content contact; an identifier of a portion of content; an identifier (e.g., URL, link, computer address) of the electronic resource; an identifier of a party approving a change to a portion of content; data (e.g., URL, link, electronic address) indicative of a location (e.g., Web site, database) of at least one change to a portion of content; a request to change a portion of content; an indication that no change to a portion of content is needed; an identifier of a party that sent the at least one communication; an indication that a portion of content has not been reviewed by its respective content contact; an indication that a portion of content has been reviewed by its respective content contact; etc.

In some embodiments, the method 200 may include the coordinator 102 doing one or more of the following: determining one or more portions of content to be reviewed by content contacts; determining one or more content contacts to be sent recency notifications; determining due dates for responses to one or more recency notifications sent during the step 202; determining approval procedures, contacts, etc for content changes; providing content approval requirement information to one or more content contacts or other parties; receiving an indication that content associated with a previously sent recency notification has not been reviewed, approved, and/or updated; sending a follow-up or reminder recency notification to a content contact from whom a response to a previous recency notification has not been received; receiving a reminder that a response to a previously sent recency notification has not yet been received; receiving a notification that content associated with a previously sent recency notification has not been reviewed by its associated content contact; receiving a confirmation of receipt of a recency notification; confirming of a receipt of a change request or a notification of no content changes needed; associating a plurality of portions of content with a respective plurality of content contacts; updating, accessing, maintaining and/or hosting a content information database; updating, accessing, maintaining and/or hosting a template information database; updating, accessing, maintaining and/or hosting a content contact information database; updating, accessing, maintaining and/or hosting a recency notification information database; updating, accessing, maintaining and/or hosting a response information database; managing or implementing an online resource; implementing a requested change to one or more portions of content; implementing a change to a template for an electronic resource; implementing, storing, and/or hosting an electronic resource containing the template or portions of content; etc.

As another example illustration of how the method 200 might be used. A company may have a primary Web site established that provides information regarding the company, the company's offices, the company's products/services, etc. A test or mirrored version of the primary Web site may exist on a second Web site. Thus, a coordinator (which may be a person, device, and/or software program) associated with the Web site may use the second Web site or other electronic resource to store copies of the content used with or displayed on the primary Web site. In addition, the second Web site may generate and send recency notifications to content contacts automatically. The second Web site may include information regarding when changes to the content on the primary Web site where last made, information regarding when one or more portions of the content on the primary Web site were last reviewed or update, information regarding previous or archived versions of the content used on the primary Web site, etc. When the coordinator sends out a recency notification to a content contact regarding one of the portions of content for the primary Web site, the notification(s) may include a link to the second Web site and/or other data indicative of the content that needs to be reviewed by the content contact. The content contact may click on or select the link such that the content contact is directed to the second Web site or a specific page of the second Web site. The content contact may have to login or provide a password to access the second Web site. In the example discussed above, the second Web site allows changes to be made to the content without affecting the primary Web site. Thus, changes to the content can be tested and reviewed without interruption of the primary Web site. At some point, the content from the second Web site may be moved to the primary Web site.

Once logged in to the second Web site, the content contact may then be allowed to review, access or retrieve the content associated with the recency notification and indicate whether or not a change to the content is needed. For example, the Web page that the content contact is directed to may include check boxes that enable or allow the content contact to indicate whether or not a change to the content is needed. If the content contact does not review the content within a designated period of time, the second Web site may sent a reminder recency notification to the content contact, send a status report to another person (e.g., the content contact's boss or manager), etc.

If the content contact indicates that a change to the content is needed via the second Web site, the second Web site may allow the content contact to edit or revise the content and/or submit edits or revisions to the content. In some cases, some changes to some content may need to be approved by another person (e.g., the content contact's boss or business leader). Thus, the second Web site may send a notification to the other person regarding the proposed change. The notification sent to the entity may be similar to the notification sent to the original content contact. That is, the notification may include information regarding the content involved, the location of the second Web site one which the content and the requested change can be reviewed, accessed or retrieved, etc. The entity may access the second Web site, review the requested change and the original content, indicate approval or denial of the requested change (e.g., by selecting an appropriate check box on the second Web site, sending a communication to the second Web site, coordinator, or content contact indicative of the denial or approval). Once the entity has reviewed the content or requested change and indicated either a denial or approval of the change, the second Web site might provide a message (e.g., email) to the coordinator 102 and/or the content contact indicative of the entity's decision. If the entity denies the change request, the content contact may need to submit a new change request or indicate that no change to the content is necessary. In other embodiments, the second Web site may require that the content contact obtain approval for the change, or indicate that approval for the change has been obtained, prior to submitted a change to the content.

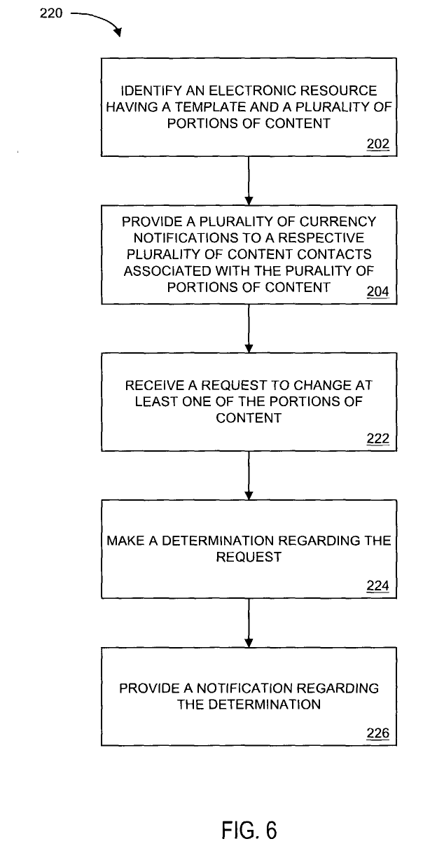

Reference is now made to FIG. 6, where a flow chart 220 is shown which represents the operation of a second embodiment of the present invention. The particular arrangement of elements in the flow chart 220 is not meant to imply a fixed order to the steps; embodiments of the present invention can be practiced in any order that is practicable. In some embodiments, some or all of the steps of the method 220 may be performed or completed by a server, user device and/or another device, as will be discussed in more detail below. The method 200 is particularly well suited for implementation by the coordinator 102. For purposes of explanation, but not limitation, the method 220 will be assumed to be implemented by or on behalf of the coordinator 102. In some embodiments, the method 220 may include some or all of the variations discussed above in regard to the method 200.

The method 220 includes the steps 202 and 204 previously discussed above. In addition, the method 220 includes a step 222 during which the coordinator 102 receives a request to change at least one of the portions of content associated with at least one of the recency notifications sent during the step 204. In some embodiments, the request may come directly or indirectly from a content contact. Alternatively, in some embodiments, the request may come directly or indirectly from a person or other entity that must approve the change to the content. For example, the content contact that receives the recency notification sent during the step 204 may have to obtain approval to the change(s) from another person or entity (e.g. a superior, a local business unit, the coordinator 102). Once that person or entity has approved the content change(s), the person or entity may send or forward a request for change(s) to the content to the coordinator 102.

The request received during the step 222 may include one or more of the following: an identifier of the content contact or other party making the request, an identifier of the portion of content for which changes are requested, a time and date that the request was made or received, data (e.g., URL, link) indicative of a location (e.g., Web site, database) where information regarding a change to content can be located, accessed or retrieved or where further information involved with the request or the requested changes can be found, information regarding an explanation or reasons for the requested change(s), contact information (e.g., telephone number, email address) for the content contact or other party making the request, an identifier associated with at least one portion of content; an indicator of at least one change to a portion of content; an indicator of an approval of at least one change to a portion of content; data indicative of a location of information regarding a at least one change to the at least one portion of content; etc.

During a step 224, the coordinator 102 or other party receiving the request during the step 22 makes a determination regarding the request. For example, the coordinator 102 or other party may accept none, some or all of the requested changes, reject some or all of the requested changes, request additional information regarding the changes or the cost, time, labor involved, etc. to make some or all of the request changes, decide forward the request on to another party for decision or analysis, review the requested changes, decide to retrieve or access an electronic resource (e.g., Web site) on which the information regarding the requested changes is stored or can be found, etc.

During a step 226, the coordinator 102 provides a notification regarding the determination made during the step 224. In some embodiments, the steps 224 and 226 may be combined into a single step. The notification may be sent to a content contact or some other party. For example, in some embodiments, the step 226 may be or include the coordinator 102 sending a notification to a content contact indicating a rejection or acceptance of some or all of the requested content changes, sending a notification to a content contact or Web site coder asking for additional information regarding the requested changes, sending a notification to a content contact or other party requesting analysis of the cost, time, labor involved, etc. in implementing the requested changes, etc. In some embodiments, the step 226 may include the coordinator 102 providing a notification to a Web site hoster or Web site coder to implement a change to the Web site or content located on the Web site.

In some embodiments, the method 220 may include the coordinator 102 doing one or more of the following: determining one or more portions of content to be reviewed by content contacts; determining one or more content contacts to be sent recency notifications; determining due dates for responses to one or more recency notifications sent during the step 202; determining approval procedures, contacts, etc for content changes; providing content approval requirement information to one or more content contacts or other parties; receiving an indication that content associated with a previously sent recency notification has not been reviewed, approved, and/or updated; sending a follow-up or reminder recency notification to a content contact from whom a response to a previous recency notification has not been received; receiving a reminder that a response to a previously sent recency notification has not yet been received; receiving a notification that content associated with a previously sent recency notification has not been reviewed by its associated content contact; receiving a confirmation of receipt of a recency notification; confirming of a receipt of a change request or a notification of no content changes needed; associating a plurality of portions of content with a respective plurality of content contacts; updating, accessing, maintaining and/or hosting a content information database; updating, accessing, maintaining and/or hosting a template information database; updating, accessing, maintaining and/or hosting a content contact information database; updating, accessing, maintaining and/or hosting a recency notification information database; updating, accessing, maintaining and/or hosting a response information database; managing or implementing an online resource; implementing a requested change to one or more portions of content; implementing a change to a template for an electronic resource; implementing, storing, and/or hosting an electronic resource containing the template or portions of content; etc.

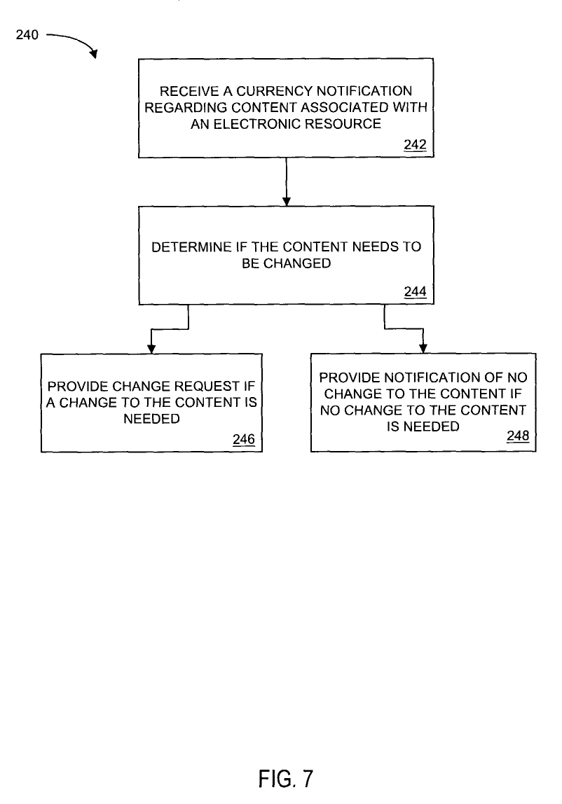

Reference is now made to FIG. 7, where a flow chart 240 is shown which represents the operation of a third embodiment of the present invention. The particular arrangement of elements in the flow chart 240 is not meant to imply a fixed order to the steps; embodiments of the present invention can be practiced in any order that is practicable. The method 240 is particularly well suited for implementation by a content contact. For purposes of explanation, but not limitation, the method 240 will be assumed to be implemented by or on behalf of the content contact 104. In some embodiments, the method 240 may include some or all of the variations discussed above in regard to the methods 200 and 220.

Processing begins at a step 242 during which the content contact 104 receives a recency notification. In some embodiments, the content contact 104 may receive the recency notification directly or indirectly from or on behalf of the coordinator 102. Thus, the step 242 may be complementary to the step 204 previously discussed above. The recency notification may be received in any form or via any type of communications channel, as previously discussed above.

During a step 244, the content contact 104 determines if the portion of content associated with the recency notification received during the step 242 needs to be changed or updated. As part of the step 244 or the method 240, the content contact may access, download, view or retrieve the content; access an electronic resource or location where the content is located; access an archive of previous changes to the content or to other content; etc.

In some embodiments, the content contact 104 may confirm receipt of the recency notification received during the step 242; forward the recency notification received during the step 242; obtain approval for any changes suggested, requested or required by the content contact 104; etc.

During a step 246, the content contact 104 may provide a change request if a change to the content associated with the recency notification received during the step 242 is needed. Typically, the change request sent during the step 246 will be provided to the coordinator 102 or other party that sent the recency notification received during the step 242. The change request may be sent in any form or format or sent via any type of communications channel, as previously discussed above. Prior to, or as part of, the step 246, the content contact 104 may request or obtain approval for the changes, receive approval for some or all of the changes, etc.

As an alternative to the step 246, in some embodiments, during a step 248, the content contact 104 may provide a notification of no change to the content if changes are not needed or if changes requested by the content contact have been denied or rejected. Typically, the notification sent during the step 248 will be provided to the coordinator 102 or other party that sent the recency notification received during the step 242. The notification may be sent in any form or format or sent via any type of communications channel, as previously discussed above.

In some embodiments, the method 240 may include the content contact 104 doing one or more of the following: determining one or more portions of content to be reviewed as a result of a recency notification received during the step 242; determining who sent the recency notification received during the step 242; determining due dates for responses to one or more recency notifications received during the step 242; determining approval procedures, contacts, etc for content changes; confirming receipt of a recency notification; receiving confirmation of a receipt of a change request or a notification of no content changes needed; receiving content approval requirement information; receiving an indication that content associated with a previously sent recency notification has not been reviewed, approved, and/or updated; receiving a follow-up or reminder recency notification regarding a portion of content; receiving a reminder that a response to a previously sent recency notification has not yet been provided; updating, accessing, maintaining and/or hosting a content information database; updating, accessing, maintaining and/or hosting a template information database; updating, accessing, maintaining and/or hosting a content contact information database; updating, accessing, maintaining and/or hosting a recency notification information database; updating, accessing, maintaining and/or hosting a response information database; managing or implementing an online resource; implementing a requested change to one or more portions of content; etc.

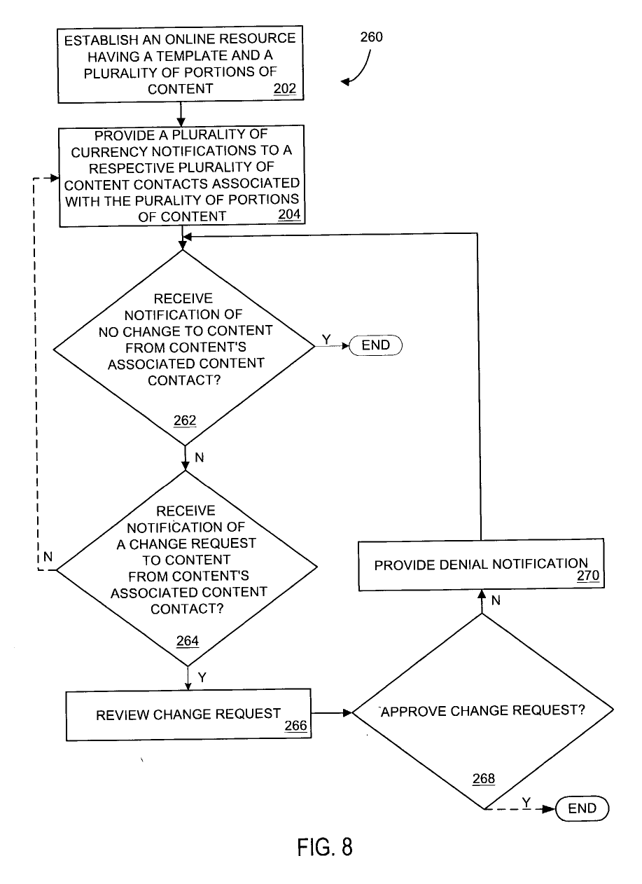

Reference is now made to FIG. 8, where a flow chart 260 is shown which represents the operation of a fourth embodiment of the present invention. The particular arrangement of elements in the flow chart 260 is not meant to imply a fixed order to the steps; embodiments of the present invention can be practiced in any order that is practicable. The method 260 is particularly well suited for implementation by the coordinator 102. For purposes of explanation, but not limitation, the method 2660 will be assumed to be implemented by or on behalf of the coordinator 102. In some embodiments, the method 260 may include some or all of the variations discussed above.

The method 260 includes the steps 202 and 204 previously discussed above. In addition, the method 260 includes a step 262 during which a determination is made as to whether an indication of no content changes has been received. If the answer to the determination made during the step 262 is “yes”, the method 260 may end or include one or more of the variations discussed above. If the answer to the determination made during the step 262 is “no”, a determination may be made during a step 264 as to whether a notification an indication of a content change request has been received. In some embodiments, if the answer to the determination made during the step 264 is “no”, the method 260 may proceed back to the step 204. In other embodiments, the method 260 may include one or more of the variations discussed above (e.g., a reminder may be sent to the content contact regarding the content that needs to be reviewed by the content contact).

If the answer to the determination made during the step 264 is “yes”, the coordinator 102 may review the change request during a step 266 and then make a decision regarding approval or rejection of some or all of the change request during a step 268.

If the answer to the determination made during the step 268 is “no”, the coordinator 102 may provide a notice of rejection or denial to the change request during a step 270. In some embodiments, the method 260 may then proceed to the step 262. If the answer to the determination made during the step 268 is “yes”, the method 260 may terminate or include one or more of the variations discussed above. For example, the coordinator 102 may implement the change request, forward the change request, provide a notification of approval of the change request, etc. . In some embodiments, the coordinator 102 may provide a notification to a Web site hoster or Web site coder to implement a change to the Web site or content located on the Web site in accordance with the approved change request.

In some embodiments, the method 260 may include the coordinator 102 doing one or more of the following: determining one or more portions of content to be reviewed by content contacts; determining one or more content contacts to be sent recency notifications; determining due dates for responses to one or more recency notifications sent during the step 202; determining approval procedures, contacts, etc for content changes; providing content approval requirement information to one or more content contacts or other parties; receiving an indication that content associated with a previously sent recency notification has not been reviewed, approved, and/or updated; sending a follow-up or reminder recency notification to a content contact from whom a response to a previous recency notification has not been received; receiving a reminder that a response to a previously sent recency notification has not yet been received; receiving a notification that content associated with a previously sent recency notification has not been reviewed by its associated content contact; receiving a confirmation of receipt of a recency notification; confirming of a receipt of a change request or a notification of no content changes needed; updating, accessing, maintaining and/or hosting a content information database; updating, accessing, maintaining and/or hosting a template information database; updating, accessing, maintaining and/or hosting a content contact information database; updating, accessing, maintaining and/or hosting a recency notification information database; updating, accessing, maintaining and/or hosting a response information database; managing or implementing an online resource; implementing a requested change to one or more portions of content; implementing a change to a template for an electronic resource; implementing, storing, and/or hosting an electronic resource containing the template or portions of content; etc.

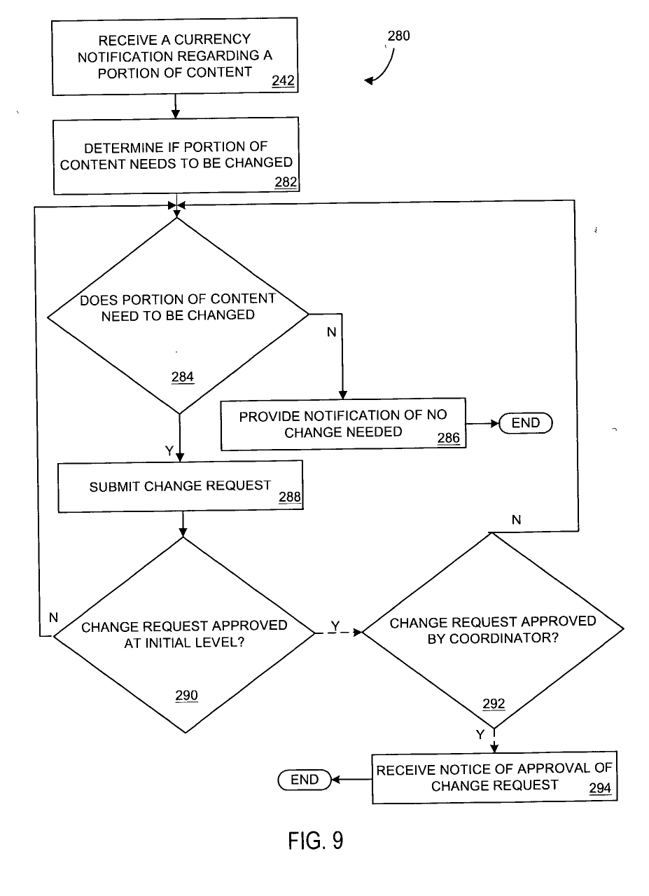

Reference is now made to FIG. 9, where a flow chart 280 is shown which represents the operation of a fifth embodiment of the present invention. The particular arrangement of elements in the flow chart 280 is not meant to imply a fixed order to the steps; embodiments of the present invention can be practiced in any order that is practicable. The method 280 is particularly well suited for implementation by a content contact. For purposes of explanation, but not limitation, the method 280 will be assumed to be implemented by or on behalf of the content contact 104. In some embodiments, the method 280 may include some or all of the variations discussed above in regard to the methods discussed above.

The method 280 includes the step 242 previously discussed above during which the content contact 104 receives a recency notification regarding one or more portions of content. In addition, the method 280 includes steps 282, 284 during which the content contact 104 determines if the portion of content needs to be changed.

If the answer to the determination made during the step 284 is “no”, the content contact may provide a notification to the coordinator 102 or another party of no needed change to the content during a step 286. If the answer to the determination made during the step “286” is “yes”, the content contact 104 may submit or otherwise provide a change request to the coordinator 102 or another party during a step 288.

In some embodiments of the method 280, the change request submitted by the content contact 104 during the step 288 may need to be approved by one or more parties (which may be or include the coordinator 102). For example, suggested changes by the content contact may need to be approved by a local business unit, a company executive, a client, etc. Thus, a party needed to provide approval to a change request may be different from a party that receives a recency notification. If the change request is not approved at the local level during a step 290, the method 280 may return to the step 284, the step 288, the step 286, or some other step. Note that only a return to the step 284 is indicated in FIG. 9. In some embodiments, the content contact 104 may provide the change request to the party making the approval or rejection decision, receive a notification from the party regarding an approval or rejection of the change request, receive a confirmation from the party of a receipt of the change request, etc.

In some embodiments, the change request submitted or otherwise provided by the content contact 104 during the step 288 may need to be approved by the coordinator 102. If the change request is approved at the local level during the step 290, the change request may still need to be approved be approved by the coordinator 102.

If the change request is not approved at the by the coordinator 102 during a step 292, the method 280 may return to the step 284, the step 288, the step 286, or some other step. Note that only a return to the step 284 is indicated in FIG. 9. In some embodiments, the content contact 104 may provide the change request to the coordinator 102, receive a notification from the coordinator 102 regarding an approval or rejection of the change request, receive a confirmation from the coordinator 102 party of a receipt of the change request, etc. For example, if the coordinator 102 approves the change request submitted during the step 288, the content contact 104 may receive an indication of such during a step 294.

In some embodiments, the method 240 may include the content contact 104 doing one or more of the following: determining one or more portions of content to be reviewed as a result of a recency notification received during the step 242; determining who sent the recency notification received during the step 242; determining due dates for responses to one or more recency notifications received during the step 242; determining approval procedures, contacts, etc for content changes; confirming receipt of a recency notification; receiving confirmation of a receipt of a change request or a notification of no content changes needed; receiving content approval requirement information; receiving an indication that content associated with a previously sent recency notification has not been reviewed, approved, and/or updated; receiving a follow-up or reminder recency notification regarding a portion of content; receiving a reminder that a response to a previously sent recency notification has not yet been provided; updating, accessing, maintaining and/or hosting a content information database; updating, accessing, maintaining and/or hosting a template information database; updating, accessing, maintaining and/or hosting a content contact information database; updating, accessing, maintaining and/or hosting a recency notification information database; updating, accessing, maintaining and/or hosting a response information database; managing or implementing an online resource; implementing a requested change to one or more portions of content; etc.

Other embodiments of the present invention are also possible. For example, in some embodiments, a method for facilitating updates to content for an electronic resource may include determining a plurality of portions of content for an electronic resource needing a review for currency; determining a plurality of content contacts associated with the plurality of portions of content; providing recency notifications to the plurality of the content contacts, wherein each of the plurality of recency notifications includes data indicative of a location of at least one of the portions of content; receiving either a request to change one of the plurality of portions of content or an indication that no change to the one of the plurality of portions of content is needed; and if the request is received, making a determination regarding approval or rejection of the request and providing a notification indicative of the determination. In some embodiments, this method may include some or all of the variations discussed above.

Coordinator Device

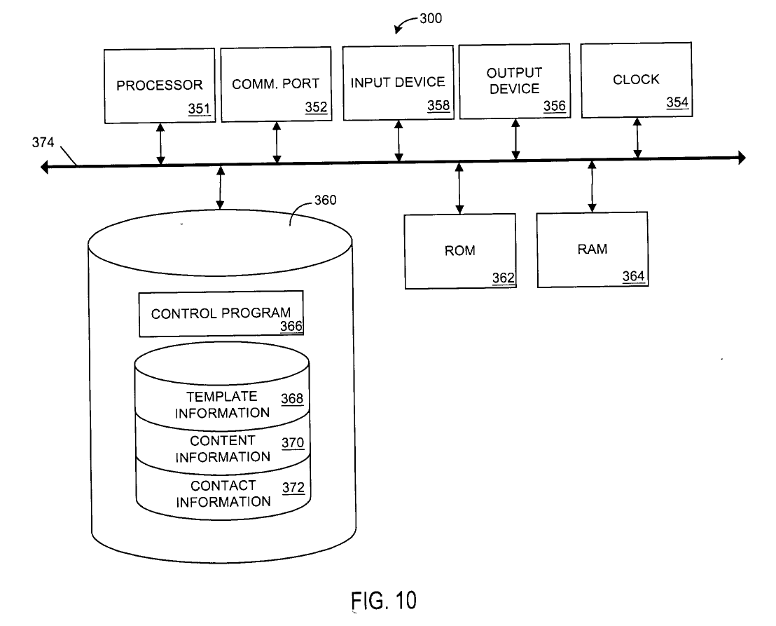

Now referring to FIG. 10, a representative block diagram of a device 300 usable by the coordinator 102 is illustrated. The coordinator device 300 may include a processor, microchip, central processing unit, or computer 350 that is in communication with or otherwise uses or includes one or more communication ports 352 for communicating with user devices and/or other devices. Communication ports may include such things as local area network adapters, wireless communication devices, Bluetooth technology, etc. The coordinator device 300 also may include an internal clock element 354 to maintain an accurate time and date for the coordinator device 300, create time stamps for communications received or sent by the coordinator device 300, etc.

If desired, the coordinator device 300 may include one or more output devices 356 such as a printer, infrared or other transmitter, antenna, audio speaker, display screen or monitor, text to speech converter, etc., as well as one or more input devices 358 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the coordinator device 300 may include a memory or data storage device 360 to store information, software, databases, communications, device drivers, templates, content, contact information, etc. The memory or data storage device 360 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The coordinator device 300 also may include separate ROM 362 and RAM 364.

The processor 350 and the data storage device 360 in the coordinator device 300 each may be, for example: (i) located entirely within a single computer or other computing device; or (ii) connected to each other by a remote communication medium, such as a serial port cable, telephone line or radio frequency transceiver. In some embodiments, the coordinator device 300 may comprise one or more computers that are connected to a remote server computer for maintaining databases.

A conventional personal computer or workstation with sufficient memory and processing capability may be used as the coordinator device 300. In some embodiments, the coordinator device 300 operates as or includes a Web server for an Internet environment. The coordinator device 300 preferably is capable of high volume transaction processing, performing a significant number of mathematical calculations in processing communications and database searches. A Pentium™ microprocessor such as the Pentium III™ or Pentium IV™ microprocessor, manufactured by Intel Corporation may be used for the processor 350. Equivalent or alternative processors are available from Motorola, Inc., AMD, or Sun Microsystems, Inc. The processor 350 also may comprise one or more microprocessors, computers, computer systems, etc.

Software may be resident and operating or operational on the coordinator device 300. The software may be stored on the data storage device 360 and may include a control program 366 for operating the server, databases, etc. The control program 366 may control the processor 350. The processor 350 preferably performs instructions of the control program 366, and thereby operates in accordance with the present invention, and particularly in accordance with the methods described in detail herein. The control program 366 may be stored in a compressed, uncompiled and/or encrypted format. The control program 366 furthermore includes program elements that may be necessary, such as an operating system, a database management system and device drivers for allowing the processor 350 to interface with peripheral devices, databases, etc. Appropriate program elements are known to those skilled in the art, and need not be described in detail herein.

The coordinator device 300 also may include or store information regarding templates, content, content contacts, products, notifications, change requests, communications, etc. For example, information regarding one or more templates may be stored in a template information database 368 for use by the coordinator device 300 or another device or entity. Information regarding content may be stored in a content information database 370 for use by the coordinator device 300 or another device or entity and information regarding one or more content contacts, local business units, or other entities may be stored in a contact information database 272 for use by the coordinator device 300 or another device or entity. In some embodiments, some or all of one or more of the databases may be stored or mirrored separately or remotely from the coordinator device 300. In addition, in some embodiments, some or all of the coordinator device 300 may be mirrored separately or remotely from the coordinator device 300.

According to an embodiment of the present invention, the instructions of the control program may be read into a main memory from another computer-readable medium, such as from the ROM 362 to the RAM 364. Execution of sequences of the instructions in the control program causes the processor 350 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 350, communication port 352, clock 354, output device 356, input device 358, data storage device 360, ROM 362, and RAM 364 may communicate or be connected directly or indirectly in a variety of ways. For example, the processor 350, communication port 352, clock 354, output device 356, input device 358, data storage device 360, ROM 362, and RAM 364 may be connected via a bus 374.

While specific implementations and hardware configurations for the coordinator device 300 have been illustrated, it should be noted that other implementations and hardware configurations are possible and that no specific implementation or hardware configuration is needed. Thus, not all of the components illustrated in FIG. 10 may be needed for a server implementing the methods disclosed herein. Therefore, many different types of implementations or hardware configurations can be used in the system 100 or for the coordinator device 300 and the methods disclosed herein are not limited to any specific hardware configuration.

In some embodiments, the coordinator device 300 may implement or host a Web site or other electronic resource. A coordinator device 300 can comprise a single device or computer, a networked set or group of devices or computers, a workstation, etc. In some embodiments, a coordinator device 300 also may function as a database server and/or as a user device.

Content Contact Device

In some embodiments, a content contact may use or include a device to communicate to and from the coordinator 102, local business units, or other parties. In some embodiments, such a content contact device may have the same structure or configuration as the coordinator device 300 illustrated in FIG. 10 and include some or all of the same components as the coordinator device 300.

Databases

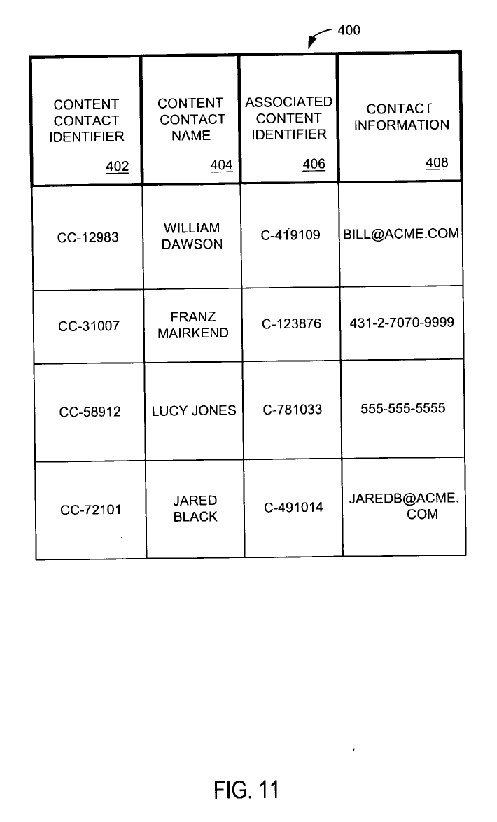

As previously discussed above, in some embodiments the coordinator 102, a content contact, a local business unit, or some other entity or device may include, use, maintain, update and/or access a content contact information database for storing or keeping information regarding one or more content contact. One representative content contact information database 400 is illustrated in FIG. 11.

The content contact information database 400 may include a content contact field 402 that may include codes or other identifiers for one or more content contacts, a contact name field 404 that may include name or other descriptive information regarding the content contacts identified in the field 402, a content identifier field 406 that may include codes or other identifiers for content associated with the content contacts identified in the field 402, and a contact information field 408 that may include telephone numbers, email addresses, postal addresses or other contact information for the content contacts identified in the field 402.

Other or different fields also may be used in the content contact information database 400. For example, in some embodiments a content contact information database may include information descriptive of the content associated with content contacts identified in the field 402, information indicative of the age, occupation, location, title, etc. of the content contacts identified in the field 402, information indicative of any local business units associated with the content contacts identified in the field 402, information regarding the last time recency notifications were was sent to the content contacts identified in the field 402 etc.

As illustrated by the content contact information database 400 of FIG. 11, the content contact identified as “CC-12983” in the field 402 is named “WILLIAM DAWSON” and is associated with the content identified as “C-419109”. The content contact identified as “CC-12983” can be reached at or contacted with the email address “BILLD@ACME.COM”.

As previously discussed above, in some embodiments the coordinator 102, a content contact, a local business unit or some other party or device may include, use, maintain, update, and/or access a content information database for storing or keeping information regarding one or more portions of content. In some embodiments, the content information database may include a content identifier field that may include codes or other identifiers for one or more portions of content; an online or electronic resource identifier field that may include codes, links, computer addresses or other identifiers indicative of the electronic resource where the content can be located; a content contact identifier field that may include codes or other identifiers associated with content contacts associated with the portions of content; a template identifier field that may include codes or other identifiers for templates associated with the portions of content; an archive of one or more previous versions of the portions of content; an archive of one or more previous changes to the portions of content; information regarding approval procedures for the portions of content; information regarding the last time one or more of the portions of content were changed; information regarding that last time a recency notification or change request was sent regarding one or more of the portions of content; information regarding sources of the portions of content; information regarding descriptions of the content; etc.

As previously discussed above, in some embodiments the coordinator 102, a content contact, a local business unit or some other party or device may include, maintain, update use and/or access a template information database for storing or keeping information regarding one or more templates. In some embodiments, the template information database may include a template identifier field that may include codes or other identifiers for one or more templates; an online or electronic resource identifier field that may include codes, links, computer addresses or other identifiers indicative of the electronic resource where the template can be located; a coordinator identifier field that may include codes or other identifiers associated with the coordinators associated with the templates; a content identifier field that may include codes or other identifiers for portions of content associated with the templates; an archive of previous versions of the templates; an archive of previous changes to the templates; information regarding approval procedures for the templates; information regarding the last time one or more of the templates were changed; information regarding that last time a recency notification or change request was sent regarding one or more portions of content associated with templates; information regarding sources of the templates; etc.

Interfaces

As previously discussed above, in some embodiments of the present invention, a system may keep track of, archive, monitor, etc. content used on or with an electronic resource (e.g., a company's Web site). The system may identify or determine when a portion of content associated with the electronic resource needs to be reviewed. At appropriate or designated times, the system may provide a one or more notifications to a respective one or more content contacts regarding one or more portions of content for an electronic resource in need of review. Different content contacts may be associated with different portions of content. The system may determine which content contacts are associated with which portions of content. The system may allow other people to view proposed changes to content, approve or deny proposed changes to content, provide messages to people that must approve changes to content that they need to review the proposed changes, etc. For purposes of discussion of the following interfaces, the interfaces will be illustrated on a computer, such as the computer 52, which may represent a device used by one or more different parties (e.g., content contact, coordinator, content change approver). Of course, different parties also may access or use the interfaces via different devices.

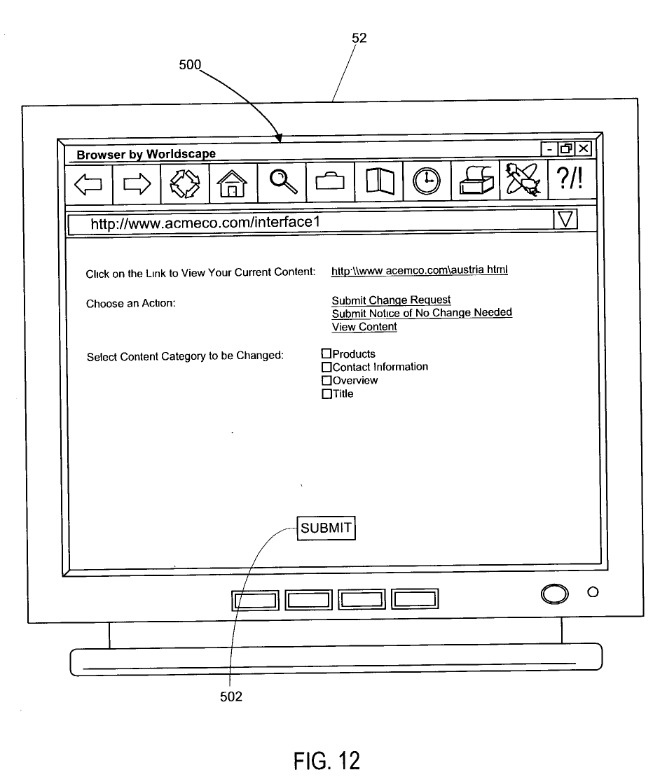

In some embodiments, different interfaces or dashboards provided by the system may enable users to obtain information regarding content, the status of recency notifications or changes requests, proposed content changes, archived content or content changes, etc. For example, now referring to FIG. 12, a recency notification sent to a content contact may include a URL (e.g. “www.acmeco.com/interface1”) that directs the content contact to a Web page 500 on which a link (e.g., “http://www.ameco.com\austria.html”) is provided that can direct the content contact to the Web page (e.g., the Web page 50 or 60) on which content is contained that needs to be reviewed by the content contact. The Web page 500 also provides the content contact with a choice of several options (e.g., submit change request, submit notice of no change to content needed) that the content contact can select. In addition, should the content contact wish to make a change to a portion of the content indicated in the currency notification, the content contact can so indicate by selecting the appropriate box next to “Product”, “Contact Information”, etc.

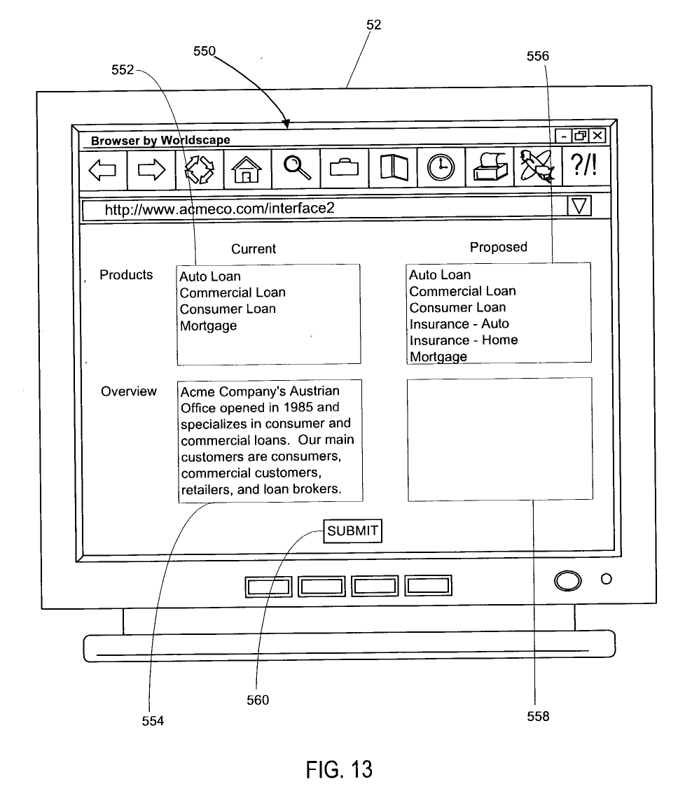

Assuming that the content contact selects the box next to “Products” or “Overview”, the content contact may be taken to another Web page or interface 550 illustrated in FIG. 13. The content contact also may have to hit a “Submit” button 502 to move to the Web page 550. As shown on the web page 550, the current version of the content for the content category “Products” is displayed in a content block or box 552 while the current version of the content for the content category “Overview” is displayed in a content block or box 554. The content in the content block 552 for the content category “Products” is the same as the content in the content block 62 for the Web page 60 illustrated in FIG. 2. Similarly, the content in the block 554 for the content category “Overview” is the same as the content in the block 66 for the Web page 60 illustrated in FIG. 2.

The content contact can enter proposed changes to the content for the content category “Products” in a content block 556 and proposed changes to the content for the content category “Overview” in a content block 558. Once the proposed changes are entered, the content contact can select “Submit” or click on a submit button 560 to submit the proposed changes to content.

In some embodiments, a proposed content change or change request submitted by a content contact may be forwarded to the coordinator and/or other party for review and/or for a decision regarding approval or rejection of the proposed new content. In other embodiments, selecting the “Submit” box or button 560 may take the content contact back to the Web page 500 where the content contact can select “Submit Change Request” to start the review process.

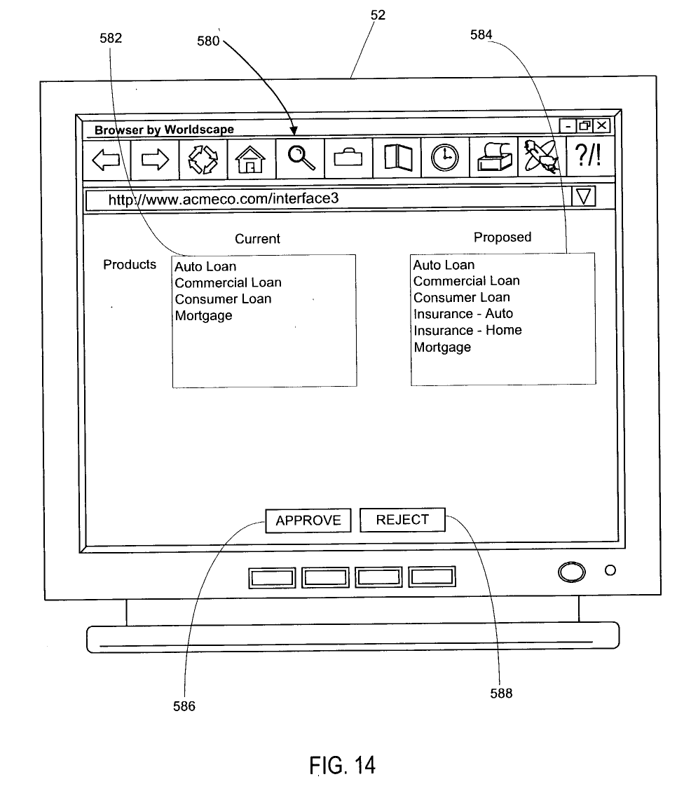

In some embodiments, a party involved in reviewing and/or approving a content change request (e.g., a coordinator) may receive a notification that a submit change request has been created. The party may be directed to a Web page that illustrates the current and proposed content changes and allows the party to approve or reject the proposed content change. For example, with regard to the proposed content change for the content category “Products” illustrated in FIG. 13, a party from which approval of the change is needed may be directed to a Web page 580 illustrated in FIG. 14 that includes the current copy of the content for the content category “Products” in a content block or box 582 and the proposed copy of the content for the content category “Products” in a content block or box 584. The party may select an “Approve” button 586 or a “Reject” button 588 to indicate approval or rejection of the proposed content change. If there other proposed changes, the party may be directed to similar Web pages or other portions (not shown) of the Web page 580 that allow the party to review, accept, and/or reject other proposed content changes.

In some embodiments, a notification regarding rejection or approval of the proposed content change may be sent to the appropriate content contact. In addition, particularly if the proposed change is approved, a notification regarding the approved content change may be sent to a party involved in hosting the content, coding the content, etc. such that the appropriate content changes can be made.

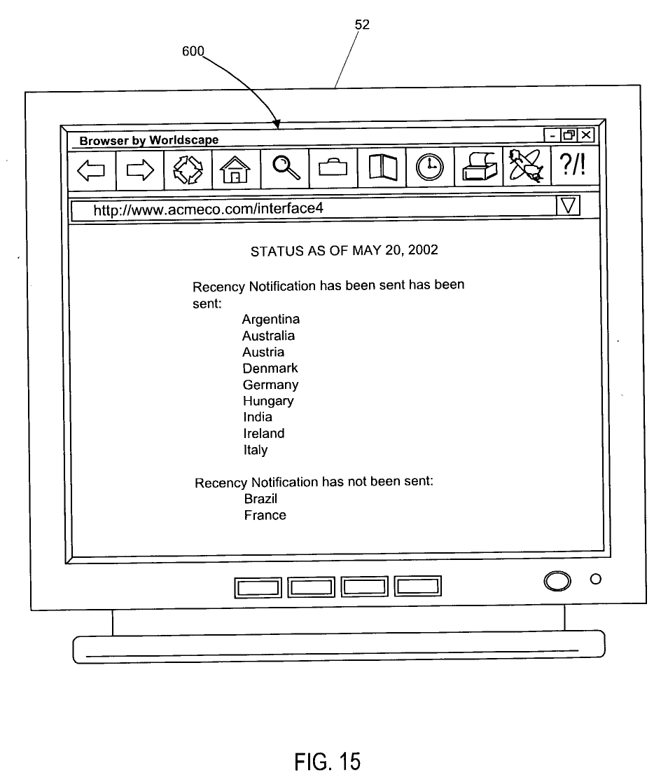

In some embodiments, an interface may be used to allow a coordinator or other party to monitor the status of one or more recency notifications. For example, a coordinator may be able to access a Web page 600 illustrated in FIG. 15. The Web page 600 provides information regarding recency notifications sent to content contacts representing different countries. For example, each content contact may represent or be associated with content or an office for a different country for the ACME Company, as described above in relation to FIGS. 1 and 2. Thus, the Web page 600 provides information regarding which country's associated content contact has been sent a recency notification. As illustrated in FIG. 15, recency notifications have been sent to the content contacts responsible for Argentina, Australia, Austria, Denmark, Germany, Hungary, India, Ireland and Italy. Recency notifications have not been sent to the content contacts responsible for Brazil and France.

While the Web page 600 provides the information by country, other embodiments may include content contact information (e.g., names, email addresses) for the content contacts associated with the different countries. If recency notifications are sent at different times, the Web page 600 also may indicate the time, date, method or channel of communication (e.g., email, instant message), etc. for recency notifications sent to content contacts for different countries.

In some embodiments, the names of the countries may act as links that call up additional information regarding the country. For example, if the word “Austria” is a selectable link on the Web page 600, clicking on it or selecting it may bring up information regarding the content contact for the country “Austria”, a copy of the recency notification sent to the content contact, the date of the recency notification, a link to content associated with the recency notification, a link to a Web page (e.g., the Web page 60 of FIG. 2) associated with the content contact or the country “Austria”, information regarding actions taken by content contact with regards to the recency notification (e.g., has the content contact viewed the recency notification, has the content contact reviewed the content associated with the recency notification, has the content contact submitted a changed request), etc.

In some embodiments, the interface or Web page 600 (or a similar Web page) may indicate if content contact has acted upon a recency notification and allow a user of the Web page 600 to view information regarding when the content contact opened or viewed the recency notification, viewed the content associated the recency notification and did not submit a change request for the content, viewed the content associated with the recency notification and did submit a change request for the content, etc. For example, if the word “Austria” is a selectable link on the Web page 600, clicking on it or selecting it may bring up information regarding some or all of such information.

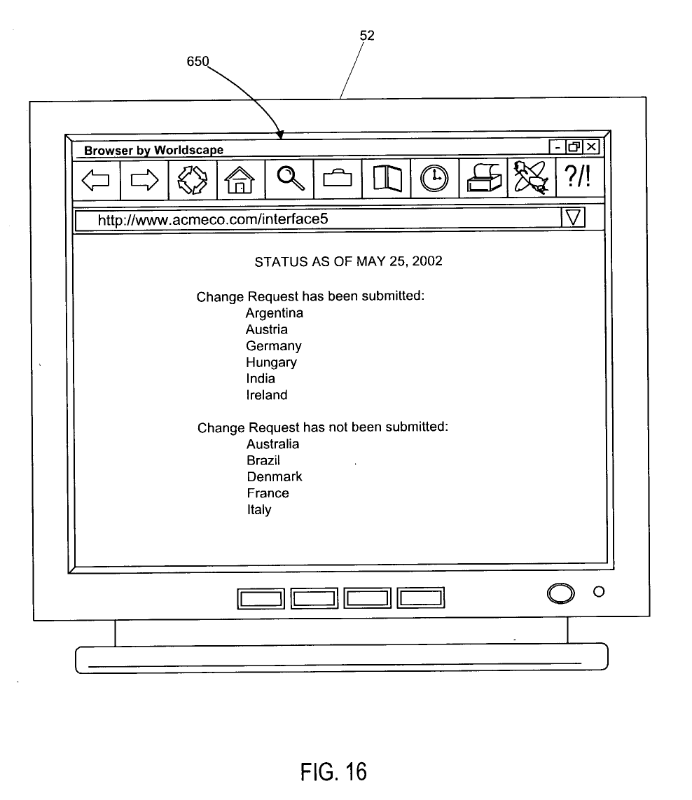

As another example of an interface that may be used by a coordinator or other party to monitor the status of one or more recency notifications, a Web page 650 as illustrated in FIG. 16 may provide information regarding submitted change requests from content contacts representing different countries. For example, content change requests have been submitted by content contacts responsible for Argentina, Australia, Germany, Hungary, India, and Ireland. While the Web page 650 provides the information by country, other embodiments may include content contact information (e.g., names, email addresses) for the content contacts associated with the different countries information regarding the time/date the change requests were submitted, information regarding whether approval is needed for a submitted change request, information regarding whether a change request has been approved or denied, etc.

In some embodiments, the names of the countries may act as links on the Web page 650 that call up additional information regarding the country. For example, if the word “Austria” is a selectable link on the Web page 650, clicking on it or selecting it may bring up information regarding the content contact for the country “Austria”, a copy of the recency notification sent to the content contact, the date of the recency notification, a link to content associated with the recency notification, a link to a Web page (e.g., the Web page 60 of FIG. 2) associated with the content contact or the country “Austria”, a copy of the submitted change request, the date/time the change request was submitted, the review and/or approval process for the submitted change request, etc.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for facilitating updates to content for an electronic resource, comprising:
providing a plurality of notifications to a respective plurality of content contacts regarding a plurality of portions of content for an electronic resource, wherein each of said plurality of content contacts is associated with a respective one of said plurality of portions of content and wherein a notification sent to one of said plurality of content contacts includes data indicative of a location of one of said plurality of portions of content associated with said one of said plurality of content contacts; and
receiving at least one communication from at least one of said plurality of content contacts regarding one of said plurality of portions of content associated with said at least one of said plurality of content contacts.

2. The method of claim 1, wherein said providing a plurality of notifications to a respective plurality of content contacts includes:
emailing a notification to a content contact.

3. The method of claim 1, wherein said receiving at least one communication from at least one of said plurality of content contacts includes:
receiving said communication as part of an email message.

4. The method of claim 1, wherein at least one of said plurality of notifications includes at least one of the following:
an identifier of a content contact;
an identifier of a portion of content;
an identifier of said electronic resource;
an identifier of a party needed for approval of a change to a portion of content;
data indicative of a location of a portion of content;
an indication of an approval process associated with a change to a portion of content is needed; and
an identifier of a party that sent said at least one of said plurality of notifications.

5. The method of claim 1, wherein said data indicative of a location of one of said plurality of said portions of content includes at least one of the following:
an electronic address;
a hyperlink to a Web site that contains said one of said plurality of said portions of content; and
a URL of a Web page that contains said one of said plurality of said portions of content.

6. The method of claim 1, wherein said at least one communication includes at least one of the following:
an identifier of a content contact;
an identifier of a portion of content;
an identifier of said electronic resource;
an identifier of a party approving a change to a portion of content;
data indicative of a location of at least one change to a portion of content;
a request to change a portion of content;
a response to a notification;
an indication that a portion of content has not been reviewed by its respective content contact;
an indication that a portion of content has been reviewed by its respective content contact;
an indication that no change to a portion of content is needed; and
an identifier of a party that sent said at least one communication.

7. The method of claim 1, wherein at least one of said plurality of portions of content includes at least one of the following:
text;
an image;
a description of a product;
a description of a service;
an advertisement;
a banner;
contact information for a corporate entity; and
contact information for an individual.

8. The method of claim 1, further comprising:
establishing said electronic resource having using said plurality of portions of content.

9. The method of claim 8, wherein said electronic resource includes at least one of the following:
a Web site;
a database; and
a log.

10. The method of claim 1, wherein said communication includes an indication that no change to one of said plurality of portions of content is needed.

11. The method of claim 1, wherein said communication includes an indication that a change to one of said plurality of portions of content is needed.

12. The method of claim 11, wherein said communication includes an indication of at least one change to one of said plurality of portions of content.

13. The method of claim 11, wherein said communication includes an indication that at least one change to one of said plurality of portions of content has been approved.

14. The method of claim 11, further comprising:
approving said change to one of said plurality of portions of content.

15. The method of claim 11, further comprising:
providing a notification indicative of an approval of said change to one of said plurality of portions of content.

16. The method of claim 11, further comprising:
rejecting said change to one of said plurality of portions of content.

17. The method of claim 11, further comprising:
providing a notification indicative of a rejection of said change to one of said plurality of portions of content.

18. The method of claim 1, further comprising:
determining at least one portion of content to be reviewed.

19. The method of claim 1, further comprising:
determining at least one content contact associated with one of said plurality of portions of content.

20. The method of claim 1, further comprising:
receiving an indication that a portion of content has not been reviewed by its respective content contact.

21. The method of claim 1, further comprising:
determining said plurality of portions of content.

22. The method of claim 1, further comprising:
associating a plurality of portions of content with a respective plurality of content contacts.

23. The method of claim 1, further comprising:
receiving an indication of an approval of a content change.

24. The method of claim 1, further comprising:
determining said plurality of content contacts.

25. The method of claim 1, wherein said at least one communication indicates that a change to at least one of said plurality of portions of content is requested and further including:
determining an entity that must approve said change.

26. The method of claim 25, further comprising:
providing a notification to said entity indicative of said change.

27. A method for facilitating updates to content for an electronic resource, comprising:
providing a plurality of notifications to a respective plurality of content contacts, wherein each of said plurality of content contacts is associated with a respective portion of content for an electronic resource and wherein a notification sent to one of said plurality of content contacts includes data indicative of a location of one of said plurality of portions of content associated with said one of said plurality of content contacts;
receiving a request to change at least one portion of content;
making a determination regarding approval or rejection of said request; and
providing a notification indicative of said determination.

28. The method of claim 27, wherein said request includes at least one of the following:
an identifier associated with said at least one portion of content;
an identifier associated with said one of said plurality of content contacts;
an indicator of at least one change to said one portion of content;
an indicator of an approval of at least one change to said portion of content;
contact information for said at least one content contact; and
data indicative of a location of information regarding a at least one change to said at least one portion of content.

29. The method of claim 27, wherein said notification includes at least one of the following:
data indicative of an approval of a change to said at least one portion of content;
data indicative of a denial of a change to said at least one portion of content; and
data indicative of a request for further information regarding said request.

30. A method for facilitating updates to content for an electronic resource, comprising:
receiving a notification regarding content associated with an electronic resource, wherein said notification includes data indicative of a location of said content;
determining if said content needs to be changed; and
providing a response to said notification, wherein said response includes a change request if a change to said content is needed or said response includes a notification that no change to said content is needed.

31. A method for facilitating review of content for an electronic resource, comprising:
determining a plurality of portions of content for an electronic resource needing a review for currency;
determining a plurality of content contacts associated with said plurality of portions of content;
providing notifications to said plurality of said content contacts, wherein each of said plurality of notifications includes data indicative of a location of at least one of said portions of content;
receiving either a request to change one of said plurality of portions of content or an indication that no change to said one of said plurality of portions of content is needed; and
if said request is received, making a determination regarding approval or rejection of said request and providing a notification indicative of said determination.

32. A system for facilitating review of content for an electronic resource, comprising:
a memory;
a communication port; and
a processor connected to said memory and said communication port, said processor being operative to:
provide a plurality of notifications to a respective plurality of content contacts regarding a plurality of portions of content for an electronic resource, wherein each of said plurality of content contacts is associated with a respective one of said plurality of portions of content and wherein a notification sent to one of said plurality of content contacts includes data indicative of a location of one of said plurality of portions of content associated with said one of said plurality of content contacts; and
receive at least one communication from at least one of said plurality of content contacts regarding one of said plurality of portions of content associated with said at least one of said plurality of content contacts.

33. A system for facilitating review of content for an electronic resource, comprising:
a memory;
a communication port; and
a processor connected to said memory and said communication port, said processor being operative to:
provide a plurality of notifications to a respective plurality of content contacts regarding a plurality of portions of content for an electronic resource, wherein each of said plurality of content contacts is associated with a respective one of said plurality of portions of content and wherein a notification sent to one of said plurality of content contacts includes data indicative of a location of one of said plurality of portions of content associated with said one of said plurality of content contacts;
facilitate access to said plurality of portions of content for review by said plurality of content contacts;
receive indications regarding need for changes to said portions of content; and
provide indications regarding whether said plurality of portions of content have been reviewed by said plurality of content contacts.

34. A computer program product in a computer readable medium for facilitating review of content for an electronic resource, comprising:
first instructions for sending a plurality of notifications to a respective plurality of content contacts regarding a plurality of portions of content for an electronic resource, wherein each of said plurality of content contacts is associated with a respective one of said plurality of portions of content and wherein a notification sent to one of said plurality of content contacts includes data indicative of a location of one of said plurality of portions of content associated with said one of said plurality of content contacts; and
second instructions for obtaining at least one communication from at least one of said plurality of content contacts regarding one of said plurality of portions of content associated with said at least one of said plurality of content contacts.
